(19) United States
(12) Patent Application Publication
(10) Pub. No.: US 2008/0286585 A1
(43) Pub. Date: Nov. 20, 2008

(54) Method to Produce Adhesiveless Metallized Polyimide Film

(76) Inventor: Hon Pong Lem, Selangor (MY)

Correspondence Address: COLLEN IP, THE HOLYOKE MANHATTAN BUILDING, 80 SOUTH HIGHLAND AVENUE, OSSINING, NY, 10562, US

(21) Appl. No.: 12/094,311

(22) PCT Filed: Nov. 10, 2006
(86) PCT No.: PCT/MY06/00025

§ 371 Date: May 20, 2008

(30) Foreign Application Priority Data
Nov. 22, 2005 (MY) PI 20055437

(51) Int. Cl. B32B 27/06; C25D 5/56

(52) U.S. Cl. 428/458; 205/158

(57) ABSTRACT

The present invention is directed to a method for the adhesiveless deposition of metal, and especially copper, to the surface of polyimides and derivatives of polyimide. More specifically, the invention is directed to the method for surface modification of polyimides and derivatives of polyimides by plasma graft co-polymerization with the vapor deposition of an appropriate functional monomer followed by subsequent deposition of metal of interest through a process of electroless and electrolytic plating. The so deposited metal-polyimide interface exhibit a T-peel adhesive strength in excess of 10 N/cm with polyimide films with a thickness of 75 .mu.m.

### TECHNICAL FIELD

The present invention relates to a metallized polyimide film in which a layer of a metal such as copper is formed on the surface of the polyimide film without any adhesive, and a method thereof, and relates particularly to a metallized polyimide film used as a flexible printed circuit or a flexible wiring board or the like.

### BACKGROUND ART

Polyimides and derivatives of polyimides are of great importance as base material to the microelectronics packaging and encapsulation industries. Polyimides are widely used specialty plastics because of their outstanding, high performance engineering properties and are particularly suited for the microelectronics packaging industries and composite applications. Polyimides offer good thermal and mechanical stability, low dielectric constants and chemical resistance. For application in microelectronics good adhesion of polyimides to metals, copper in particular, is essential. According to the configuration of the particular assembly, the copper metal is introduced on to the polyimide surface through vacuum evaporation/depositions, or by methods of the direct lamination of the metal foil, films or sheet to the polymer surface.

In the area of flexible printed circuit and flexible microelectronics packaging, the constant need to increase packaging density, necessitates the reduction of the thickness of both the film metallization and film. Henceforth, this class of metallized polyimide film produced without adhesive grows in importance and utilization.

Besides the need for thinner metal-polyimide films the presence of an adhesive has further disadvantages like susceptibility to copper migration, relatively poorer dimensional stability, inferior thermal characteristics and poorer scalability.

The strategies of surface chemical and physical modification have been widely implemented in polyimides and other polymers for adhesion improvement with metals and with other polymer substrates.

Patent literature contains numerous disclosures of surface modification of polyimides for adhesion enhancement. However, most of the prior art is related to plasma or chemical surface treatment or related to vacuum deposition of an intermediate layer of metal prior to chemical electroplating. A few of the prior art disclosures are related to surface modification via graft copolymerization in conjunction with a metal foil. Almost no prior art is directed to the modification of polyimides via plasma graft copolymerization followed by electroless and electroplating to form the metallization layer.

In patent literature search, there is no relevant process which involves the simultaneous modification of polyimide surface via plasma graft copolymerization with a functional monomer and the subsequent chemical deposition of the metal resulting in the complete absence of an adhesive. The present invention exhibits substantial increase in adhesion strength with the additional plasma graft polymerization step.

There was one patent application filing (No. US20040831177 20040426) by Lin, which claimed a method of manufacturing an adhesiveless flexible substrate. However, our method differs from this said filing, wherein the metallized polyimide is further subjected to an additional and critical post heat treatment process, wherein without which the claimed adhesion level will not be achieved.

### SUMMARY OF INVENTION

It is an object of the present invention to provide a new method for the direct deposition of a metal, via a chemical process such as copper, to surfaces of polyimides under atmospheric conditions. It is also an object of the present invention to effect the said deposition in the absence of an added adhesive. These and other objects and advantages of the present invention are obtained by providing a method for modification of pristine, pretreated, or preactivated polyimide surfaces via low temperature plasma graft copolymerization of an appropriate functional monomer through vapor deposition of the latter. The desired metal film is subsequently deposited via a process of electroless plating, which includes a prior activation with a catalyst on the surface. For the pre-treatment, the surfaces of the polyimides can also be activated by corona discharge, ozone treatment, UV irradiation and electron beam bombardment.

It is also another object of the present invention to provide a method to produce a metallized polyimide film wherein for applications where the metallization is of copper, the interfacial layer in the metallized polyimide film thus produced will exhibit the property of resisting the diffusion of copper into the polyimide film.

The objects and advantages of the present invention are best achieved when the polyimide-metal interfaces from the plasma graft copolymerization and after chemical deposition undergo a post heat treatment process of at least 100° C. in vacuum or in inert gas, and then returned to room temperature via a slow cooling or annealing process.

The objects and advantages of the present invention can be achieved when the monomer used for the surface graft copolymerization are selected from the group of vinyl monomers which contain nitrogen heteroatoms or nitrogen functionalities in the pendent group or groups. The monomers are also selected from the family containing multiple vinyl group functionalities, as well as from the family which contains epoxide functional groups.

The objects and advantages of the present invention are obtained when the metals for chemical deposition are preferably selected from copper.

The objects and advantages of the present invention are obtained when the polymers for deposition are selected from polyimides and their derivatives.

### DESCRIPTION OF PREFERRED EMBODIMENTS

The present invention is directed to a method of chemical deposition of a metal, such as copper, to polyimides in the absence of an applied adhesive and at temperature substantially below the glass transition temperature or melting point of polyimides. The adhesion strength, as measured in terms of T-peel strength, of the polyimides-metal interfaces can exceed 9 N/cm strength for a 75 .mu.m thick Kapton film. While not wishing to be bound by any theory, it is believed that the functional groups of the plasma grafted polymer chains on the polyimide surface undergo charge transfer interaction with the electrolessly deposited metal surface, to give rise to the strong adhesion between the metal and the polymer.

In the preferred method, the polyimides surface is preactivated by gas plasma treatment, ozone treatment, corona discharge treatment, or ultraviolet irradiation, although pristine polyimides can also be used. The pristine and preactivated polyimides are then subjected to plasma graft copolymerization of a reactive vinyl monomer introduced in vapor form. The grafted polyimide surface are then subjected to a process of electroless plating for the chemical deposition of a metal such as copper, to form a conductive layer, after a prior activation with a catalyst, and is later subjected to electroplating process of the same metal to increase the thickness of the conductive layer.

The preferred monomers are selected from the family of vinyl family polymers with functional groups which are capable of undergoing charge transfer interactions with the deposited metal. Thus, the monomers are selected from the family containing the imidazole, epoxide, anionic, cationic or amphoteric functional groups.

The preferred application and the best advantages of the present invention are obtained from polyimide films or sheets. Thus, in the preferred method, the surface of the polyimides is pretreated with a d.c. (direct current), a.c. (alternating current), radio frequency gas plasma, corona discharge or ozone. Pristine (untreated) polyimide surface is grafted at lower efficiency than its pretreated counter-parts. The selection of frequency and gas type (in the case of plasma treatment) and treatment time for all treatments are important. Long pretreatment time can result in excessive etching or degradation of the polymer surface.

There are no particular restrictions on the thickness of the polyimide film, although values from 25 to 125 .mu.m are preferred.

The material for the polyimide film may utilize any polyimide resin typically used for this type of application, and both BPDA type polyimide resins and PMDA type polyimide resins are suitable. Generally, polyimide films using BPDA (biphenyltetracarboxylic acid) as a raw material (such as the commercial product “Upilex” manufactured by Ube Industries) offer superior dimensional stability under heat and moisture absorption, as well as excellent rigidity, although the adhesion strength of these polyimide films with metallic thin films is relatively lower compared with PMDA type polyimides. Polyimide films using PMDA (pyromellitic dianhydride) as a raw material (such as the commercial product “Kapton” manufactured by DuPont-Toray Co., Ltd., or the commercial product “Apical” manufactured by Kaneka Corporation) therefore is preferred for adhesion strength with metallic thin films.

### EXAMPLES

The following specific examples are provided to illustrate this invention and the manner in which it may be carried out. It will be understood, however, that the specific details given in each example have been selected for purpose of illustration and are not to be constructed as a limitation on the invention. Example 1 provides more details on the conduct of the plasma graft copolymerization, and deposition experiment.

### Example 1

In a preferred experimental scale process, a PMDA type polyimide film e.g. a Kapton film, of 7.0 cm times 1.5 cm in size 75 .mu.m in thickness was pretreated in O₂ plasma with an a.c. power of 0.5 W/cm.sup.2 for 5 minutes, with vacuum pressure of 100 Pa. Immediately after this pre-treatment, the monomer in the form of 1-vinylimidazole (VIDZ) was introduced in vapor form into the plasma chamber by Argon gas, under an a.c. plasma of 0.1 W/cm.sup.2 for 3 minutes with the vacuum pressure maintained at 100 Pa.

After removal from the plasma chamber, the polyimide film is first washed thoroughly with water, and then immersed into a copper electroless plating bath for the deposition of a thin layer of copper in the range of 100 nm-200 nm thick. (Enplate Series Electroless plating solution supplied by Enthone Inc, part of Cookson Electronics Group, PLC) The activator solution supplied by this company contained palladium as the catalyst for electroless copper plating. The sample is then placed in a vacuum heating oven elevated at a rate of 3° C./min to 140° C. for at least 4 hours, and then slowly cooled to room temperature in another 4 hours. After the heat treatment, the sample is then immersed into a copper sulphate bath to further build up the thickness of electroplated copper layer to 25 .mu.m. The T-peel strength of the copper layer thus prepared exceeded 10N/cm.

### Example 2

In another preferred experiment, a similar polyimide film is similarly pre-treated but with Argon plasma instead of O2. The pre-treated film is subsequently exposed to the atmosphere for at least half hour in order to form surface peroxides on its surface. The sample is then placed back into the plasma chamber and similarly subjected to plasma grafting conditions and all other subsequent steps as in Example 1. The T-peel strength of the copper film thus prepared, exceeded 9 N/cm.

### Example 3

In another preferred experiment, a similar polyimide film is directly subjected to O2 plasma simultaneously in the presence of the VIDZ monomer, thereby omitting the initial O2 plasma pretreatment. The sample is then similarly subjected to copper electrolessly and electrolytically plated as in example 1. The T-peel strength of the copper film thus prepared, exceeded 9 N/cm.

### Example 4

In another preferred experiment, in a procedure in all manners similar to the example 1, with the exception the monomers used is 1-allyl imidazole. The T-peel of the copper film thus prepared exceeded 8 N/cm.

### Example 5

In another preferred experiment, following the exact procedure as in example 1, but with the exception that the monomer used is 2-vinyl pyridine, and subsequent heat treatment temperature set at 120.deg.C The T-peel of the copper film thus prepared exceeded 3 N/cm.

### Example 6

In another preferred experiment, following the exact procedure as in example 1, but with the exception that the monomer used is 4-vinyl pyridine, and the subsequent heat treatment temperature set at 120.deg.C. The T-peel of the copper film thus prepared exceeded 3.5 N/cm.

### Example 7

In another preferred experiment, following the exact procedure as in example 1, but with the exception that the monomer used is acryloyl morpholine, and the subsequent heat treatment temperature set at 100.deg.C. The T-peel of the copper film thus prepared exceeded 3.5 N/cm.

### Example 8

In another preferred experiment, following the exact procedure as in example 1, but with the exception that the monomer used is glycidyl methacrylate. The T-peel of the copper film thus prepared exceeded 2.5 N/cm.

### Example 9

In another preferred experiment, following the exact procedure as in example 1, but with the exception that nickel electroless plating bath was used for the deposition of the thin layer of Nickel in the range of 300-400 nm. The T-peel strength of the nickel-copper film thus prepared exceeded 8.5 N/cm.

### Example 10

In another preferred experiment, following the exact procedure as in example 1, but with the exception that BPDA polyimide film e.g. Upilex by UBE Industries was used in place of the Kapton film. The T-peel of the copper film thus prepared exceeded 7.5 N/cm.

### Example 11

In another preferred experiment, following the exact procedure as in example 1, the metallized film is subjected to a pressure cooker test (PCT). The conditions for the PCT are 121.deg.C, humidity of 100%, 2 atmosphere for a duration of 48 hours. The T-peel strength of the copper film after PCT shows a mean decrease of 15.6% compared to that before PCT.

### Comparative Example 1

In another preferred experiment, following the exact procedure as in example 1, but with the exception that no plasma graft polymerization with the VIDZ was performed after plasma pre-treatment. The T-peel strength of the copper film thus prepared exceeded only 2 N/cm.

1. A metallized polyimide film comprising of a polyimide film which has undergone plasma grafting copolymerization with a functional monomer, and a conductive metallic layer which is formed on top of the polyimide film.

2. A method for imparting adhesion between a chemically deposited metal and a polyimide or to a polyimide derivative comprising the following steps of:
a) modifying the surface of the polyimide or the derivative of a polyimide via plasma graft co-polymerization with vapor deposition of a functional monomer;
b) subjecting the pre-treated polyimide or the derivative of a polyimide to chemical deposition of the metal via a process of electroless and electrolytic plating; and
c) subjecting the said polyimide subsequently to post heat treatment of at least 100° C. in vacuum or in an inert gas.

3. The method according to claim 2, wherein the polyimide or the derivative of a polyimide is pre-activated prior to the surface graft copolymerization in step (a), by pre-treating the polyimide substrate with plasma, ozone, corona discharge, UV irradiation or a means so that peroxides or hydroxyl peroxide species are formed on the surface of the polyimide or the derivative of a polyimide.

4. The method according to claim 2, wherein the polyimide or the derivative of a polyimide is in the form of a film.

5. The method of claim 2, in which the chemically deposited metal is selected from copper, gold, palladium or nickel and is in the form of a solution.

6. The method of claim 2, wherein the polyimide or polyimide derivative is used in pristine form.

7. The method of claims 2, wherein the functional monomer is a vinyl monomer comprising a nitrogen heteroatom of a nitrogen functionality in at least one pendant group or comprising an epoxide functional group.

8. The method of claim 7, wherein the functional monomer is 1-vinyl imidazole, 1-allyl imidazole, 2-vinyl pyridine, 4-vinyl pyridine, acryloyl morpholine, glycidyl methacrylate or allyl glycidyl ether.
